(19) United States
(12) Patent Application Publication
(10) Pub. No.: US 2004/0038629 A1
(43) Pub. Date: Feb. 26, 2004

(54) Internal diameter cutting blades and methods

(75) Inventor: Jesse B. Griggs, Vancouver, WA (US)

Correspondence Address: OLIFF & BERRIDGE, PLC, P.O. BOX 19928, ALEXANDRIA, VA, 22320, US

(73) Assignee: SEH AMERICA, INC., Vancouver, WA

(21) Appl. No.: 10/226,141

(22) Filed: Aug. 23, 2002

(51) Int. Cl. B28D 1/04

(52) U.S. Cl. 451/49; 125/13.01; 451/41

(57) ABSTRACT

An internal diameter blade includes an inner diameter having an inner cutting edge, an outer diameter having an outer mounting edge, a blade surface defined between the inner edge and the outer edge, and a plurality of cuts in the blade surface. In various embodiments, the cuts reduce a vacuum between the blade and a material being cut by the blade. In various embodiments, the plurality of cuts comprises a plurality of holes through the blade. In various embodiments, the plurality of cuts comprises at least one groove extending in a direction away from the inner edge. A cutting method uses an internal diameter blade to reduce a vacuum between the blade and a material being cut by the blade.

### BACKGROUND OF THE INVENTION

1. Field of Invention

This invention relates to internal diameter cutting blades and cutting methods using such blades. More specifically, this invention relates to internal diameter cutting blades and methods of cutting wafers.

2. Description of Related Art

A substantial majority of monocrystalline silicon used to make silicon wafers for the microelectronics industry is produced by crystal growing apparatus using the well-known Czochralski process. The Czochralski process basically involves melting high-purity polycrystalline silicon in a quartz crucible in a specially designed furnace to form a silicon melt. A small seed crystal is suspended above the silicon melt on a pull wire or the like, which is arranged to be raised and lowered in a generally vertical direction. The seed crystal is lowered into contact with the silicon melt. The seed crystal is then raised slowly from the silicon melt so that a silicon crystal rod is grown by drawing silicon from the silicon melt. Examples of Czochralski crystal growing systems are described in U.S. Pat. Nos. 5,406,905; 5,911,825; and 5,976,245, each of which is incorporated herein by reference in its entirety.

The silicon crystal rod is cut or sliced into thin wafers, for example, for use in semiconductors. Various internal or inner diameter and external or outer diameter blades are known for such a purpose. For example, U.S. Pat. No. 4,677,963 to Ajamian, U.S. Pat. No. 4,850,331 to Balck, U.S. Pat. No. 5,133,783 to Tanabe et al., U.S. Pat. No. 5,218,948 to Mazaki and U.S. Pat. No. 6,203,416 B1 to Mizuno et al., each of which is incorporated herein by reference in its entirety, disclose various internal diameter blades.

### SUMMARY OF THE INVENTION

This invention is based upon the realization that the operation and performance of internal diameter blades may be improved. Further, it would be desirable to be able to limit or reduce potential damage to the blade, the wafer and/or the crystal rod. Thus, various embodiments of the internal diameter blades and cutting methods according to this invention serve to reduce a vacuum pressure between a surface of an internal diameter blade and a material being cut by the blade.

In various embodiments of the internal diameter blades and cutting methods according to this invention, an internal diameter blade comprises an inner diameter having an inner cutting edge, an outer diameter having an outer mounting edge, a blade surface defined between the inner cutting edge and the outer mounting edge, and a plurality of cuts in the blade surface. In various embodiments, the plurality of cuts in the blade surface comprises means for reducing a vacuum between the blade and a material being cut by the blade.

According to various embodiments, the cuts in the blade surface may comprise a plurality of holes through the blade, at least one groove extending in a direction away from the inner cutting edge, or a combination thereof.

According to various embodiments, when the cuts in the blade surface comprise holes, the holes may decrease in size in a direction away from the inner cutting edge. Additionally or alternatively, the plurality of holes may comprise at least one series of holes extending in the direction away from the inner cutting edge. In such case, the at least one series of holes may include holes that are offset relative to a preceding hole in a direction opposite a direction of rotation of the blade.

According to various embodiments, when the cuts in the blade surface comprise at least one groove, an outer end of the at least one groove may be offset relative to an inner end of the at least one groove in a direction opposite a direction of rotation of the blade. Also, the at least one groove may be curved toward the outer mounting edge in a direction opposite a direction of rotation of the blade.

According to various embodiments, the at least one groove may comprise at least one channel that increases in width in a direction away from the inner cutting edge. The at least one channel may have at least one secondary groove.

In various embodiments of the cutting methods according to this invention, an object to be cut is inserted into an inner diameter of an internal diameter blade having a plurality of cuts in a blade surface defined between an inner cutting edge and an outer mounting edge, at least one of the object and the internal diameter blade is moved in a cutting direction, and the internal diameter blade is rotated in a direction of rotation.

In various embodiments, rotating the internal diameter blade in a direction of rotation comprises reducing a vacuum between at least a portion of the object being cut and the internal diameter blade.

These and other features and advantages of this invention are described in or are apparent from the following detailed description of various exemplary embodiments of the internal diameter cutting blades and cutting methods according to this invention.

### BRIEF DESCRIPTION OF THE DRAWINGS

The invention will be described in relation to the following drawings in which like reference numerals refer to like elements, and wherein:

FIG. 1 is a perspective view of an exemplary internal diameter blade cutting a thin wafer from a crystal rod;

FIG. 2 is a side view of the exemplary internal diameter blade of FIG. 1 cutting a thin wafer with a fluid being supplied to the blade;

FIG. 3 is a side view of a first exemplary embodiment of an internal diameter blade according to this invention;

FIG. 4 is a side view of a second exemplary embodiment of an internal diameter blade according to this invention;

FIG. 5 is a side view of a third exemplary embodiment of an internal diameter blade according to this invention; and

FIG. 6 is a side view of a fourth exemplary embodiment of an internal diameter blade according to this invention.

### DETAILED DESCRIPTION OF EXEMPLARY EMBODIMENTS

While the internal diameter blades and methods according to this invention are suitable for cutting or slicing various materials, the internal diameter blades and methods according to this invention are particularly advantageous for cutting or slicing a single-crystal silicon rod. Accordingly, for ease of understanding, the internal diameter blades and methods according to this invention are described herein with reference to a cutting a wafer from a single-crystal silicon rod. This invention, however, is not to be considered to be limited by the description of the internal diameter blades and methods with regard to use for a particular material or in a particular industry.

The internal diameter blades and methods according to this invention solve problems that may occur when cutting or slicing using conventional internal diameter blades. In various embodiments of the internal diameter blades and cutting methods according to this invention, an internal diameter blade comprises an inner diameter having an inner cutting edge, an outer diameter having an outer mounting edge, a blade surface defined between the inner cutting edge and the outer mounting edge, and a plurality of cuts in the blade surface. The cuts in the blade surface tend to reduce the possibility that the material being cut will stick to the blade surface.

When the material being cut sticks to the blade surface, the material may be thrown from the holder or the blade may be damaged, for example, by bending or breaking. While each part of the material being cut may be held in a manner that the part being cut off is pulled away from the blade, undesirable under-cut chips may be formed during the cutting.

The cuts in the blade surface tend to reduce a vacuum that is formed between the material being cut and the blade surface during cutting. This helps to reduce or even eliminate sticking between the material being cut and the blade surface during cutting, without adversely affecting the cutting.

FIG. 1 illustrates an exemplary internal diameter blade 100 cutting a thin wafer 12 from a crystal rod 10. The annular internal diameter blade 100 comprises an inner diameter 110 having an inner cutting edge 112, an outer diameter 120 having an outer mounting edge 122, and a blade surface 130 defined between the inner cutting edge 112 and the outer mounting edge 122.

As shown in FIG. 1, the internal diameter blade 100 is rotated in a direction of rotation R by a suitable machine that engages, for example, holes (not shown) in the outer mounting edge 122 of the internal diameter blade 100. The crystal rod 10 is inserted through the inner diameter 110 and positioned so that a desired thickness of the thin wafer 12 will be cut. At least one of the crystal rod 10 and the internal diameter blade 100 is moved so that the crystal rod 10 and the inner cutting edge 112 are brought into contact and then moved at a desired rate so that the thin wafer 12 is cut from the crystal rod 10.

It should be understood that any suitable mechanism, either known or hereafter developed, for holding and moving the crystal rod 10 may be used. Further, it and that should be understood that any suitable machine, either known or hereafter developed, for moving and/or rotating the internal diameter blade 100 may be used. These details are omitted as they are well-known by those skilled in the art.

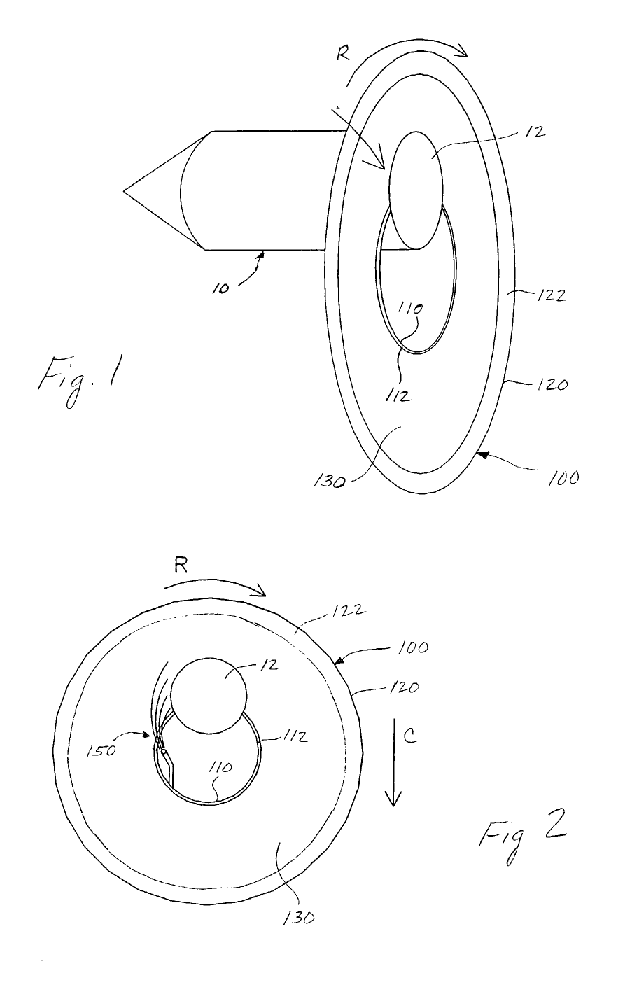

As illustrated in FIG. 2, as the internal diameter blade 100 is rotated and as at least one of the crystal rod 10 and the internal diameter blade 100 is moved to cut the thin wafer 12 in a cutting direction C, a fluid 150 may be supplied to the internal diameter blade 100. The fluid 150 may be any suitable fluid that aids the cutting, for example, a cooling fluid, a lubricating fluid or the like.

As described above, the internal diameter blades and cutting methods according to this invention are useful whether or not such a fluid is supplied.

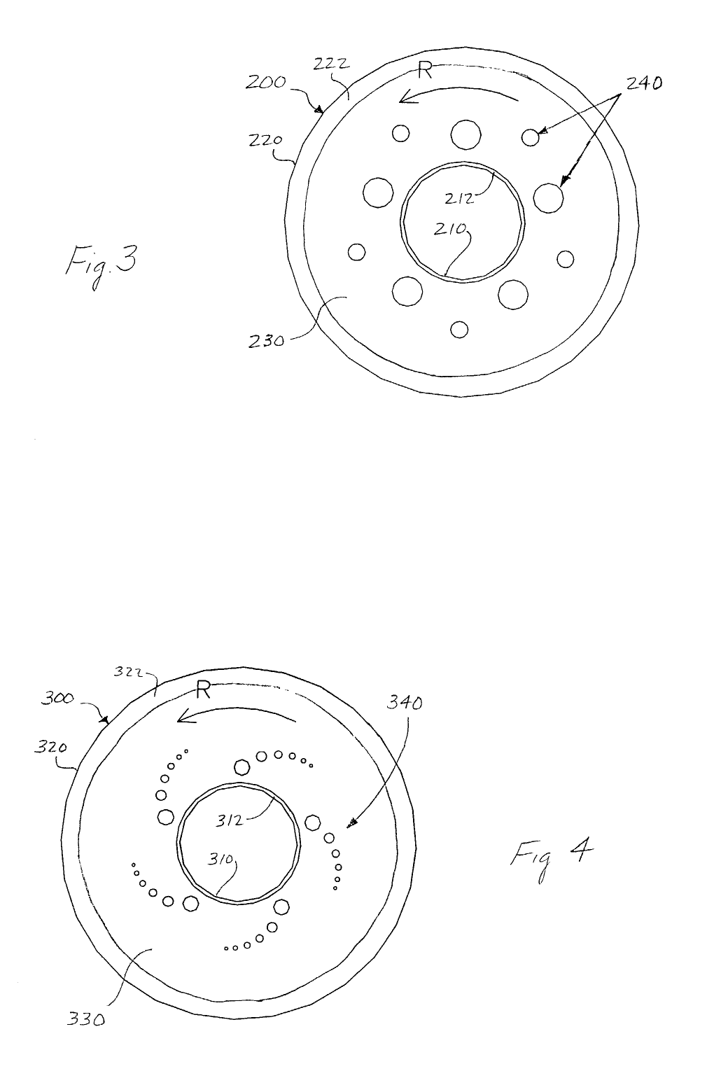

Exemplary embodiments of an internal diameter blade according to this invention are shown in FIGS. 3-6. While the various configurations of these exemplary embodiments are described below, it should be understood that any combination of the various features of these configurations is contemplated.

A first exemplary embodiment of an internal diameter blade 200 according to this invention is shown in FIG. 3. The annular internal diameter blade 200 comprises an inner diameter 210 having an inner cutting edge 212, an outer diameter 220 having an outer mounting edge 222, and a blade surface 230 defined between the inner cutting edge 212 and the outer mounting edge 222.

As shown in FIG. 3, the internal diameter blade 200 includes a plurality of cuts in the form of holes 240 through the blade surface 230. The holes 240 may vary in size and/or location, and may be patterned, random or uniform in size and/or location. As shown, the holes 240 may decrease in size in a direction away from the inner cutting edge 212. As described above, as the internal diameter blade 200 is rotated, the holes 240 formed through the blade surface 230 help to reduce the possibility that the internal diameter blade 200 will stick to a material being cut. This decreases costs associated with damage to the blade or to the material being cut.

A second exemplary embodiment of an internal diameter blade 300 according to this invention is shown in FIG. 4. The annular internal diameter blade 300 comprises an inner diameter 310 having an inner cutting edge 312, an outer diameter 320 having an outer mounting edge 322, and a blade surface 330 defined between the inner cutting edge 312 and the outer mounting edge 322.

As in the first exemplary embodiment, the internal diameter blade 300 according to the second exemplary embodiment includes a plurality of cuts in the form of holes 340 through the blade surface 330. In the second exemplary embodiment, the holes 340 are formed in a pattern or series. As shown, the holes 340 decrease in size in a direction away from the inner cutting edge 312. Also, the series of holes 340 includes holes that are offset relative to a preceding hole in a direction opposite a direction of rotation R of the internal diameter blade 300. As described above, as the internal diameter blade 300 is rotated, the holes 340 formed through the blade surface 330 may help to reduce a vacuum that may be formed between the internal diameter blade 300 and the material being cut.

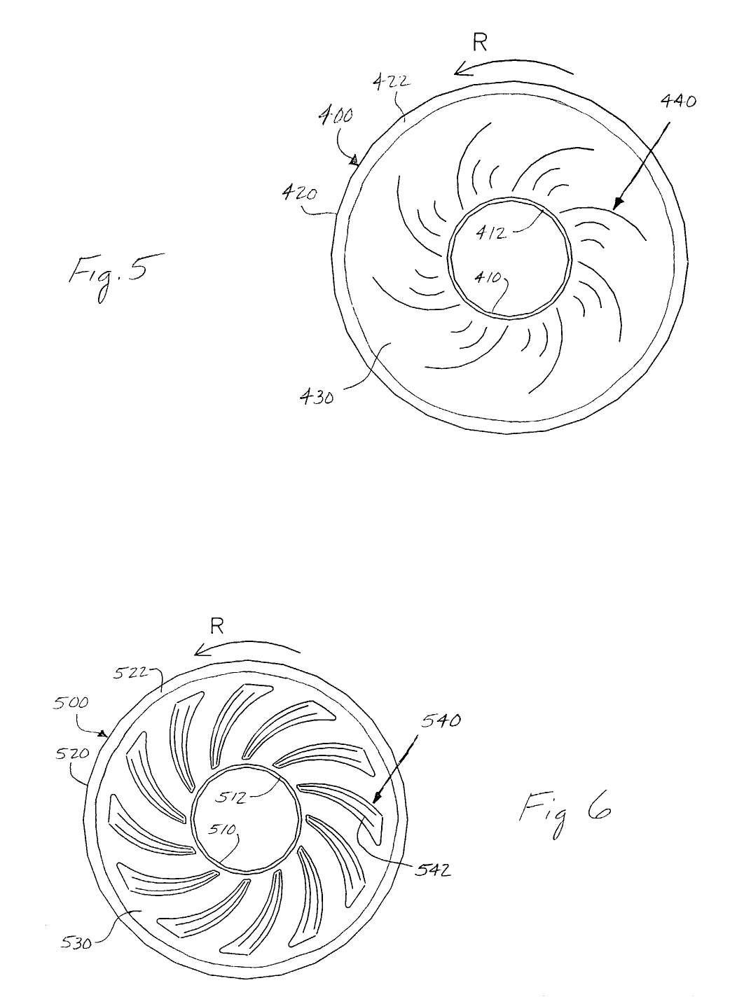

A third exemplary embodiment of an internal diameter blade 400 according to this invention is shown in FIG. 5. The annular internal diameter blade 400 comprises an inner diameter 410 having an inner cutting edge 412, an outer diameter 420 having an outer mounting edge 422, and a blade surface 430 defined between the inner cutting edge 412 and the outer mounting edge 422.

As shown in FIG. 5, the internal diameter blade 400 includes a plurality of cuts in the form of a plurality of grooves 440 in the blade surface 430. The grooves 440 may vary in size and/or location, and may be patterned, random or uniform in size and/or location. As shown, the grooves 440 may extend in a direction away from the inner cutting edge 412. Further, the grooves 440 may be formed as a series of grooves that decrease in size in a direction opposite a direction of rotation R of the internal diameter blade 400.

As shown in FIG. 5, an outer end, nearest the outer mounting edge 422, of the one or more of the grooves 440 may be offset relative to an inner end, nearest the inner cutting edge 412, of the respective groove 440 in a direction opposite the direction of rotation R of the internal diameter blade 400. Also as shown in FIG. 5, one or more of the grooves 440 may be curved toward the outer mounting edge 422 in a direction opposite the direction of rotation R of the internal diameter blade 400.

A fourth exemplary embodiment of an internal diameter blade 500 according to this invention is shown in FIG. 6. The annular internal diameter blade 500 comprises an inner diameter 510 having an inner cutting edge 512, an outer diameter 520 having an outer mounting edge 522, and a blade surface 530 defined between the inner cutting edge 512 and the outer mounting edge 522.

As shown in FIG. 6, the internal diameter blade 500 includes a plurality of cuts in the form of a plurality of channels 540 in the blade surface 530. The channels 540 may vary in size and/or location, and may be patterned, random or uniform in size and/or location. As shown, the channels 540 may extend in a direction away from the inner cutting edge 512. Further, the channels 540 may increase in width in a direction away from the inner cutting edge 512.

As shown in FIG. 6, an outer end, nearest the outer mounting edge 522, of the one or more of the channels 540 may be offset relative to an inner end, nearest the inner cutting edge 512, of the respective channel 540 in a direction opposite the direction of rotation R of the internal diameter blade 500. Also as shown in FIG. 6, one or more of the channels 540 may be curved toward the outer mounting edge 522 in a direction opposite the direction of rotation R of the internal diameter blade 500.

One or more of the channels 540 may have a secondary groove 542. The secondary groove 542 may be defined within or may extend beyond a respective one of the channels 540. As with the channels 540, an outer end of the secondary groove 542 may be offset relative to an inner end of the secondary groove 542 in a direction opposite the direction of rotation R of the internal diameter blade 500. Also, the secondary groove 542 may be curved toward the outer mounting edge 522 in a direction opposite the direction of rotation R of the internal diameter blade 500.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. An internal diameter blade, comprising:
an inner diameter having an inner cutting edge;
an outer diameter having an outer mounting edge;
a blade surface defined between the inner cutting edge and the outer mounting edge; and
a plurality of cuts in the blade surface.

2. The internal diameter blade of claim 1, wherein the plurality of cuts in the blade surface constitutes means for reducing a vacuum between the blade and a material being cut by the blade.

3. The internal diameter blade of claim 1, wherein the plurality of cuts in the blade surface comprises a plurality of holes through the blade.

4. The internal diameter blade of claim 3, wherein the holes decrease in size in a direction away from the inner cutting edge.

5. The internal diameter blade of claim 4, wherein the plurality of holes comprises at least one series of holes extending in the direction away from the inner cutting edge.

6. The internal diameter blade of claim 5, wherein the at least one series of holes includes holes that are offset relative to a preceding hole in a direction opposite a direction of rotation of the blade.

7. The internal diameter blade of claim 3, wherein the plurality of holes comprises at least one series of holes extending in a direction away from the inner cutting edge.

8. The internal diameter blade of claim 7, wherein the at least one series of holes includes holes that are offset relative to a preceding hole in a direction opposite a direction of rotation of the blade.

9. The internal diameter blade of claim 1, wherein the plurality of cuts in the blade surface comprises at least one groove extending in a direction away from the inner cutting edge.

10. The internal diameter blade of claim 9, wherein an outer end of the at least one groove is offset relative to an inner end of the at least one groove in a direction opposite a direction of rotation of the blade.

11. The internal diameter blade of claim 9, wherein the at least one groove is curved toward the outer mounting edge in a direction opposite a direction of rotation of the blade.

12. The internal diameter blade of claim 9, wherein the at least one groove comprises at least one channel that increases in width in a direction away from the inner cutting edge.

13. The internal diameter blade of claim 12, wherein an outer end of the at least one channel is offset relative to an inner end of the at least one channel in a direction opposite a direction of rotation of the blade.

14. The internal diameter blade of claim 12, wherein the at least one channel is curved toward the outer mounting edge in a direction opposite a direction of rotation of the blade.

15. The internal diameter blade of claim 12, wherein the at least one channel has at least one secondary groove.

16. The internal diameter blade of claim 15, wherein an outer end of the at least one channel is offset relative to an inner end of the at least one channel in a direction opposite a direction of rotation of the blade, and an outer end of the at least one secondary groove is offset relative to an inner end of the at least one secondary groove in a direction opposite a direction of rotation of the blade.

17. The internal diameter blade of claim 12, wherein the at least one channel and the at least one secondary groove are curved toward the outer mounting edge in a direction opposite a direction of rotation of the blade.

18. A cutting method, comprising:
inserting an object to be cut into an inner diameter of an internal diameter blade having a plurality of cuts in a blade surface defined between an inner cutting edge and an outer mounting edge;
moving at least one of the object and the internal diameter blade in a cutting direction; and
rotating the internal diameter blade in a direction of rotation.

19. The cutting method of claim 18, wherein rotating the internal diameter blade in a direction of rotation comprises reducing a vacuum between at least a portion of the object being cut and the internal diameter blade.
